(19) United States
(12) Patent Application Publication
(10) Pub. No.: US 2005/0004277 A1
(43) Pub. Date: Jan. 6, 2005

(54) Halogen-containing flame retardant combination

(75) Inventors: Sebastian Hoerold, Diedorf (DE); Susanne Knop, Hamburg (DE); Martin Sicken, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/840,861

(22) Filed: May 7, 2004

(30) Foreign Application Priority Data
May 13, 2003 (DE) 103 21 298.1

(51) Int. Cl. C08K 5/34; C09K 21/00; C08K 5/49

(52) U.S. Cl. 524/99; 252/609; 524/115

(57) ABSTRACT

The invention relates to a flame retardant combination which comprises, as component A, at least one phosphinic salt of the formula (I), and/or one diphosphinic salt of the formula (II), and/or polymers of these, 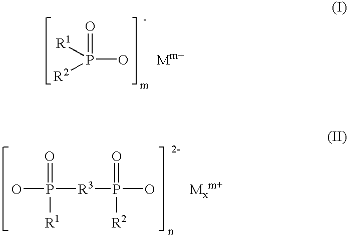 where
R¹, R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Ti, Zn, Fe, Zr, Ce, Bi, Sr, Mn, Li, Na; K and/or a protonated nitrogen base; m is from 1 to 4; n is from 1 to 4; x is from 1 to 4 and also comprises at least one synergistic halogen-containing component as component B.

The present invention relates to a flame retardant combination and to its use.

Salts of phosphinic acids (phosphinates) have proven to be effective flame-retardant additives for thermoplastic polymers (DE-A-2 252 258 and DE-A-2 447 727). Calcium phosphinates and aluminum phosphinates have been described as particularly effective in polyesters, and, when compared with the alkali metal salts, for example, give less impairment of the properties of the polymeric molding composition materials (EP-A-0 699 708).

Synergistic combinations of phosphinates with certain nitrogen-containing compounds have also been found, these being more effective flame retardants than the phosphinates alone in very many polymers (EP-A-0 892 829, and also DE-A-197 34 437, and DE-A-197 37 727).

Among the effective synergists described are melamine and melamine compounds, for example melamine cyanurate and melamine phosphate, which themselves also have some degree of flame-retardant action in certain thermoplastics, but are markedly more effective in combination with phosphinates.

Higher-molecular-weight derivatives of melamine, such as the condensates melam, melem, and melon, have been described as flame retardants, as have appropriate reaction products of these compounds with phosphinic acid, such as dimelamine pyrophosphate and melamine polyphosphates. However, relatively large amounts have to be added in thermoplastics, in particular in the case of glass-fiber-reinforced materials.

Despite this, the effectiveness of the combinations remains unsatisfactory in particular plastics. Although fire tests such as UL 94 V-0 can be passed using relatively small additions, there are other classifications of flame-retardant materials which cannot be achieved, or can be achieved only using very large additions. Among these is the IEC 60695 glow-wire test, for example.

It is therefore an object of the present invention to provide flame retardant combinations which exhibit excellent flame-retardant action for various fire classifications, even when the amounts in the appropriate plastics, in particular in thermoplastic polymers, are only very small. In particular, the inventive flame retardant combination should provide plastics which achieve not only UL 94 V-0 classification but also pass the glow-wire test at temperatures above 750° C.

This object is achieved by way of a flame retardant combination which comprises, as component A, at least one phosphinic salt of the formula (I), and/or one diphosphinic salt of the formula (II), and/or polymers of these, 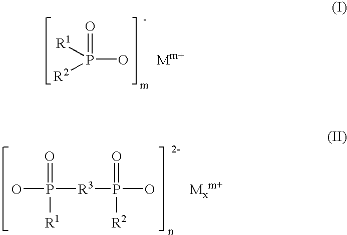
where
R¹, R² are identical or different and are C₁-C₆-alkyl, linear or branched, and/or aryl;
   R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na;
K and/or a protonated nitrogen base;
m is from 1 to 4;
n is from 1 to 4;
x is from 1 to 4
   and also comprises at least one synergistic halogen-containing component as component B.
   M is preferably calcium, aluminum, or zinc.

Protonated nitrogen bases are preferably the protonated bases of ammonia, melamine, triethanolamine, and in particular NH₄⁺.

Preferred meanings of R¹ and R², identical or different, are C₁-C₆-alkyl, linear or branched, and/or phenyl.

Preferred meanings of R¹ and R², identical or different, are methyl, ethyl, n-propyl, isopropyl, n-butyl, tert-butyl, n-pentyl and/or phenyl.

Preferred meanings of R³ are methylene, ethylene, n-propylene, isopropylene, n-butylene, tert-butylene, n-pentylene, n-octylene or n-dodecylene.

Other preferred meanings of R³ are phenylene or naphthylene.

Other preferred meanings of R³ are methylphenylene, ethylphenylene, tert-butylphenylene, methylnaphthylene, ethylnaphthylene or tert-butylnaphthylene.

Other preferred meanings of R³ are phenylmethylene, phenylethylene, phenylpropylene or phenylbutylene.

The halogen-containing component B preferably comprises bromine- or chlorine-containing acid components or bromine- or chlorine-containing alcohol components, or bromine- or chlorine-containing aromatic and aliphatic compounds.

The bromine- or chlorine-containing acid components or bromine- or chlorine-containing alcohol components preferably comprise hexachloroendomethylenetetrahydrophthalic acid, tetrabromophthalic acid, tetrabromophthalic anhydride, dibromoneopentyl glycol, trischloroethyl phosphate, and/or trischloropropyl phosphate.

The bromine- or chlorine-containing aromatic and aliphatic compounds preferably comprise brominated polystyrenes, polybromobenzyl acrylates, tetrabromobisphenol A and derivatives, polybrominated diphenyl ethers, ethylenebistetrabromophthalimide, brominated epoxy oligomers, polybrominated diphenylethanes, hexabromocyclododecane, chloroparaffins, and/or dodecachloropentacyclooctadecadiene.

The inventive flame retardant combination preferably comprises, as further component C, at least one nitrogen compound, phosphorus compound, or phosphorus-nitrogen compound.

Component C preferably comprises melamine phosphate, dimelamine phosphate, melamine pyrophosphate, melamine polyphosphates, melam polyphosphates, melem polyphosphates, and/or melon polyphosphates.

The inventive flame retardant combination preferably comprises at least one nitrogen compound as further component C.

The nitrogen compounds are preferably compounds of the formulae (III) to (VIII), or a mixture of these, 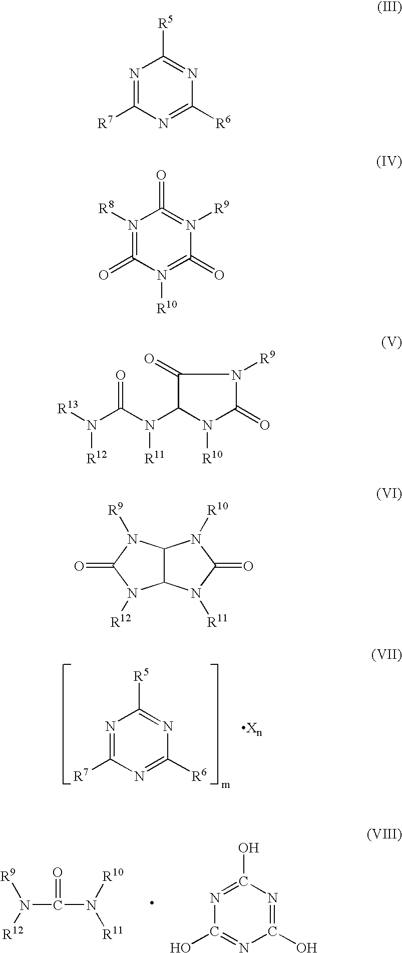
where
R⁵ to R⁷ are hydrogen, C₁-C₈-alkyl, C₅-C₁₆-cycloalkyl or -alkylcycloalkyl, optionally sustituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R⁹, or else a system of N-alicyclic or N-aromatic nature,
R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy or C₆-C₁₂-aryl or -arylalkyl,
R⁹ to R¹³ are the same as the groups for R⁸, or else —O—R⁸,
m and n, independently of one another, are 1, 2, 3 or 4,
X is acids which can form adducts with triazine compounds (III).

The inventive flame retardant combination preferably comprises, as component C, oligomeric esters of tris(hydroxyethyl) isocyanurate with aromatic polycarboxylic acids, or comprises benzoguanamine, tris(hydroxyethyl) isocyanurate, allantoin, glycoluril, melamine, melamine cyanurate, dicyandiamide, guanidine, and/or carbodiimides.

The inventive flame retardant combination preferably comprises, as component C, nitrogen-containing phosphates of the formulae (NH₄)_{y} H_{3-y} PO₄ or (NH₄ PO₃)_{z}, where y is from 1 to 3 and z is from 1 to 10 000.

The inventive flame-retardant combination preferably comprises, as component D, a synthetic inorganic compound, and/or a mineral product.

Component D preferably comprises an oxygen compound of silicon, magnesium compounds, metal carbonates of metals of the second main group of the Periodic Table, red phosphorus, zinc compounds, or aluminum compounds.

The oxygen compounds of silicon preferably comprise salts and esters of orthosilicic acid and condensates thereof, silicates, zeolites, and silicas, glass powder, glass-ceramic powder, or ceramic powder; the magnesium compounds comprise magnesium hydroxide, hydrotalcites, magnesium carbonates, or magnesium calcium carbonates; the zinc compounds comprise zinc oxide, zinc stannate, zinc hydroxystannate, zinc phosphate, zinc borate, or zinc sulfides; the aluminum compounds comprise aluminum hydroxide or aluminum phosphate.

The inventive flame retardant combination preferably comprises from 0.1 to 99.9% by weight of component A and from 0.1 to 99.9% by weight of component B.

The inventive flame retardant combination preferably comprises from 10 to 70% by weight of component A, from 10 to 70% by weight of component B, and from 0 to 60% by weight of component C.

The inventive flame retardant combination preferably comprises from 20 to 65% by weight of component A, from 15 to 65% by weight of component B, from 0 to 60% by weight of component C, and from 0 to 20% by weight of component D.

The inventive flame retardant combination preferably comprises from 30 to 60% by weight of component A, from 30 to 50% by weight of component B, from 0 to 50% by weight of component C, and from 0 to 5% by weight of component D.

The inventive flame retardant combination preferably comprises from 30 to 60% by weight of component A, from 30 to 50% by weight of component B, from 0 to 40% by weight of component C, and from 0 to 2% by weight of component D.

The invention also provides the use of the inventive flame retardant combination for rendering thermoplastic polymers flame-retardant.

The thermoplastic polymers preferably comprise HI (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene).

The thermoplastic polymers particularly preferably comprise polyamide, polyester, and ABS.

In the use of the inventive flame retardant combination, it is preferable that, independently of one another, component A is used at a concentration of from 0.1 to 30% by weight, and component B at a concentration of from 0.1 to 30% by weight, based in each case on the plastics molding composition. Component C is preferably used at from 0 to 5% by weight, and component D at from 0 to 30% by weight.

In the use of the inventive flame retardant combination, it is preferable that, independently of one another, component A is used at a concentration of from 3 to 40% by weight, component B at a concentration of from 1 to 25% by weight, component C at a concentration of from 3 to 20% by weight, and component D at a concentration of from 0 to 5% by weight, based in each case on the plastics molding composition.

In the use of the inventive flame retardant combination, it is preferable that, independently of one another, component A is used at a concentration of from 5 to 30% by weight, component B at a concentration of from 2 to 15% by weight, component C at a concentration of from 4 to 15% by weight, and component D at a concentration of from 0 to 2% by weight, based in each case on the plastics molding composition.

The international patent application WO 97/39053 describes the thermoplastic polymers in which the inventive flame retardant combinations may be used effectively.

Among these are:

Polymers of mono- or diolefins, for example polypropylene, polyisobutylene, polybutylene, poly-1-butene, polyisoprene and polybutadiene, and also polymers of cycloolefins, for example of cyclopentene or of norbornene; also polyethylene, which may have crosslinking if desired; e.g. high-density polyethylene (HDPE), high-density high-molecular-weight polyethylene (HDPE-HMW), high-density ultrahigh-molecular-weight polyethylene (HDPE-UHMW), medium-density polyethylene (MDPE), low-density polyethylene (LDPE), linear low-density polyethylene (LLDPE), or low-density branched polyethylene (VLDPE).

Mixtures of the abovementioned polymers, for example mixtures of polypropylene with polyisobutylene, polypropylene with polyethylene (e.g.: PP/HDPE, PP/LDPE) and mixtures of various polyethylene grades, for example LDPE/HDPE.

Copolymers of mono- or of diolefins with one another or with other vinyl monomers, e.g. ethylene-propylene copolymers, linear low-density polyethylene (LLDPE) and mixtures of the same with low-density polyethylene (LDPE), propylene-1-butene copolymers, propylene-isobutylene copolymers, ethylene-1-butene copolymers, etc.; and also ethylene-alkyl acrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene or ethylidenenorbornene; and also mixtures of copolymers of this type with one another or with other polymers, like polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and polyalkylene-carbon monoxide copolymers of alternating or random structure and mixtures of these with other polymers, e.g. with polyamides.

Polystyrene, poly(p-methylstyrene), poly(α-methylstyrene).

Copolymers of styrene or α-methylstyrene with dienes or with acrylics, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methacrylate; high-impact-strength mixtures made from styrene copolymers with another polymer, e.g. with a polyacrylate, with a diene polymer or with an ethylene-propylene-diene terpolymer; and also block copolymers of styrene, e.g. styrene-butadiene-styrene, styrene-isoprene-styrene, styrene-ethylene/butylene-styrene or styrene-ethylene/propylene-styrene.

Graft copolymers of styrene or α-methylstyrene, e.g. styrene on polybutadiene, styrene on polybutadiene-styrene copolymers or on polybutadiene-acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene, styrene and maleimide on polybutadiene; styrene and alkyl acrylates and, respectively, alkyl methacrylates on polybutadiene; styrene and acrylonitrile on ethylene-propylene-diene terpolymers; styrene and acrylonitrile on polyalkyl acrylates or on polyalkyl methacrylates; styrene and acrylonitrile on acrylate-butadiene copolymers, and also mixtures of these with other polymers, like ABS polymers, MBS polymers, ASA polymers or AES polymers, for example.

Halogen-containing polymers, e.g. polychloroprene, chlorinated rubber, chlorinated or brominated copolymer made from isobutylene-isoprene (halogenated butyl rubber), chlorinated or chlorosulfonated polyethylene, copolymers of ethylene with chlorinated ethylene, epichlorohydrin homo- and copolymers, in particular polymers made from halogen-containing vinyl compounds, e.g. polyvinyl chloride, polyvinylidene chloride, polyvinyl fluoride, polyvinylidene fluoride; and also copolymers of these, for example vinyl chloride-vinylidene chloride, vinyl chloride-vinyl acetate and vinylidene chloride-vinyl acetate.

Polymers derived from α,β-unsaturated acids or from derivatives of these, for example polyacrylates and polymethacrylates, butyl-acrylate-impact-modified polymethyl methacrylates, polyacrylamides and polyacrylonitriles.

Copolymers of the abovementioned monomers with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers and acrylonitrile-alkyl methacrylate-butadiene terpolymers.

Polymers derived from unsaturated alcohols and amines and, respectively, from their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; and also copolymers of these with the olefins mentioned under 1.

Polyacetals, such as polyoxymethylene, and also those polyoxymethylenes which contain comonomers, e.g. ethylene oxide; polyacetals modified with thermoplastic polyurethanes, with acrylates or with MBS.

Polyphenylene oxides, polyphenylene sulfides and mixtures of these oxides or sulfides with styrene polymers or with polyamides.

Polyamides and copolyamides derived from diamines and from dicarboxylic acids and/or from aminocarboxylic acids or from the corresponding lactams, for example nylon-4, nylon-6, nylon-6,6, 6,10, 6,9, 6,12, 4,6,12,12, nylon-11, nylon-12, aromatic polyamides based on m-xylene, diamine and adipic acid; polyamides prepared from hexamethylenediamine and iso- and/or terephthalic acid and, if desired, from an elastomer as modifier, e.g. poly-2,4,4-trimethylhexamethylene-terephthalamide or poly-m-phenyleneisophthalamide. Block copolymers of the abovementioned polyamides with polyolefins, with olefin copolymers, with ionomers or with chemically bonded or grafted elastomers; or with polyethers, e.g. with polyethylene glycol, polypropylene glycol or polytetramethylene glycol, and also EPDM- or ABS-modified polyamides or copolyamides; and also polyamides condensed during processing (“IM polyamide systems”).

Polyureas, polyimides, polyamideimides, polyetherimides, polyesterimides, polyhydantoins and polybenzimidazoles.

Polyesters derived from dicarboxylic acids and from dialcohols and/or from hydroxycarboxylic acids or from the corresponding lactones, for example polyethylene terephthalate, polybutylene terephthalate, poly-1,4-dimethylolcyclohexane terephthalate, polyhydroxybenzoates, and also block polyetheresters derived from polyethers having hydroxyl end groups; polyesters modified with polycarbonates or with MBS.

Polycarbonates and polyester carbonates.

Polysulfones, polyether sulfones and polyether ketones.

Mixtures (polyblends) of the abovementioned polymers, e.g. PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/PA 6.6, and copolymers.

The expression “phosphinic salt” hereinafter encompasses salts of phosphinic and of diphosphinic acids, and polymers of these.

The phosphinic salts, prepared in an aqueous medium, are in essence monomeric compounds. Depending on the reaction conditions, polymeric phosphinic salts may also be produced in some circumstances.

Examples of phosphinic acids which are a suitable constituent of the phosphinic salts are: Dimethylphosphinic acid, ethylmethylphosphinic acid, diethylphosphinic acid, methyl-n-propyl-phosphinic acid, methanedi(methylphosphinic acid), benzene-1,4-(dimethylphosphinic acid), methylphenylphosphinic acid and diphenylphosphinic acid.

The inventive salts of the phosphinic acids may be prepared by known methods, for example those described in more detail in EP-A-0 699 708. By way of example, the phosphinic acids here are reacted in aqueous solution with metal carbonates, metal hydroxides, or metal oxides.

The amount of the phosphinic salt to be added to the polymers may vary widely. Use is generally made of from 1 to 50% by weight, based on the plastics molding composition. The ideal amount depends on the nature of the polymer and on the nature of components B, and on the type of the actual phosphinic salt used. Preference is given to from 3 to 40% by weight, in particular from 5 to 30% by weight, based on the plastics molding composition.

The abovementioned phosphinic salts may be used in various physical forms for the inventive flame retardant combination, depending on the nature of the polymer used and on the desired properties. For example, the phosphinic salts may be ground to give a fine-particle form in order to achieve better dispersion in the polymer. If desired, it is also possible to use mixtures of various phosphinic salts.

The phosphinic salts used according to the invention in the flame retardant combination are thermally stable, and neither decompose the polymers during processing, nor affect the preparation process for the plastics molding composition. The phosphinic salts are non-volatile under the usual conditions of preparation and processing for thermoplastic polymers.

The flame-retardant components A and B, and also, where appropriate, C and D may be incorporated into thermoplastic polymers by, for example, premixing all of the constituents in the form of powders and/or pellets in a mixer, and then homogenizing them in the polymer melt in a compounding assembly (e.g. a twin-screw extruder). The melt is usually drawn off in the form of an extrudate, cooled, and pelletized. Components A and B, and also, where appropriate, C and D, may also be separately introduced directly into the compounding assembly by way of a metering system.

It is also possible to admix the flame-retardant components A and B, and also, where appropriate, C and D, with ready-to-use polymer pellets or ready-to-use polymer powder, and process the mixture directly in an injection-molding machine to give moldings. In the case of polyesters, for example, the flame-retardant additives A and B, and also, where appropriate, C and D, may also be added to the polyester composition before polycondensation is complete.

Alongside the inventive flame-retardant combination composed of A and B, and also, where appropriate, C and D, the molding compositions may also receive additions of fillers and reinforcing materials, such as glass fibers, glass beads, or minerals, such as chalk. In addition, other additives may also be present in the molding compositions, examples being antioxidants, light stabilizers, lubricants, colorants, nucleating agents, or antistatic agents. Examples of the additives which may be used are given in EP-A-0 584 567.

The flame-retardant plastics molding compositions are suitable for producing moldings, films, filaments, and fibers, for example by injection molding, extrusion, or pressing.

Thermoplastic polymers which comprise the inventive flame-retardant combinations, and, where appropriate, fillers and reinforcing materials, and/or other additives, as defined below, are hereinafter terms plastics molding compositions.

Fire protection for electrical and electronic equipment has been specified in specifications and standards for product safety. In the USA, fire-protection testing and fire-protection approval procedures are carried out by Underwriters Laboratories (UL). The UL specifications are nowadays accepted worldwide. Fire tests for plastics were developed in order to determine the resistance of the materials to ignition and flame spread.

Depending on fire-protection requirements, the materials have to pass horizontal combustion tests (UL 94 HB specification), or the more stringent vertical test (UL 94 V-2, V-1, or V-0). These tests simulate low-energy ignition sources which occur in electrical devices and to which plastics parts of electrical modules can be exposed.

### EXAMPLES

1. Components used

Commercially available polymers (pellets)
Nylon-6,6 (GRPA 6.6): ®Durethan AKV 30 (Bayer AG, Germany) comprises 30% of glass fibers.
Polybutylene terephthalate(GRPBT): ®Celanex 2300 GV1/30 (Ticona, Germany) comprises 30% of glass fibers.

Flame retardant components (pulverulent):

Aluminum salt of diethylphosphinic acid, hereinafter termed DEPAL.

®Melapur 200 (melamine polyphosphate), hereinafter termed MPP, DSM Melapur, Netherlands

®Saytex 7010, brominated polystyrene, hereinafter termed Br—PS, Albemarle, Louvain-la-Neuve, Belgium

FR-1025, polypentabromobenzyl acrylate, hereinafter termed PBBA, Dead Sea Bromine Group, Beer Sheva, Israel
2. Preparation, processing, and testing of flame-retardant plastics molding compositions

The polymers were processed in a twin-screw extruder (Berstorff ZE 25/40) at temperatures of from 260 to 310° C. (GRPA 6.6) or from 240 to 280° C. (GRPBT). The homogenized polymer extrudate was drawn off, cooled in a water bath, and then pelletized.

The flame-retardant components were mixed with one another in the ratio given in the tables, and added to the polymer melt through a side feed.

After adequate drying, the molding compositions were processed at melt temperatures of from 270 to 320° C. (GRPA 6.6) or from 260 to 280° C. (GRPBT) in an injection-molding machine (Arburg 320 C Allrounder) to give test specimens, and tested and classified for flame retardancy on the basis of the UL 94 (Underwriters Laboratories) test and the IEC 60695-2 glow-wire test.

The flowability of the molding compositions was determined by determining the melt volume index (MVR) at 275° C./2.16 kg. A sharp rise in the MVR value indicates polymer degradation.

Processing properties in polyester were assessed on the basis of specific viscosity (SV). After adequate drying, the pellets of the plastics molding composition were used to prepare a 1.0% strength solution in dichloroacetic acid, and the SV value was determined. The higher the SV value, the less polymer degradation occurred during the incorporation of the flame-retardant.

Unless stated otherwise, all of the experiments of a particular series were carried out under identical conditions (temperature profiles, screw geometries, injection-molding parameters, etc.) for reasons of comparability.

Tables 1 and 3 show comparative examples which use a flame retardant combination based on the aluminum salt of diethylphosphinic acid (DEPAL) and on the nitrogen-containing synergist melamine polyphosphate (MPP), or else use the bromine flame retardant bromopolystyrene (Br—PS) or polypentabromobenzyl acrylate (PBBA) alone.

The results of the examples which used the flame retardant mixture of the invention have been listed in tables 2 and 4. All of the amounts are given as % by weight, and are based on the plastics molding composition including the flame retardant combination and additives.

The examples show that the inventive additives (mixture composed of the components phosphinate, bromine flame retardant and, where appropriate, nitrogen synergist, give improved flame-retardant action.

The glow-wire ignition temperature (GWIT to IEC 60695-1-13) which can be achieved by using phosphinate and, where appropriate, nitrogen synergist, or else bromine flame retardant alone is only 700° C.

If use is now made of an inventive flame retardant mixture composed of phosphinate, bromine flame retardant and, where appropriate, nitrogen synergist (examples 8 to 11 and 18 to 21), the glow-wire ignition temperature now found is above 800° C.

If use is made of phosphinate and, where appropriate, nitrogen synergist or bromine flame retardant alone, the glow-wire ignition temperature in PBT is at most 700° C., similar to that in polyamide.

If use is made of the inventive combination of phosphinate, where appropriate nitrogen synergist, and bromine flame retardant, the glow-wire ignition temperature found is above 800° C.

Unless otherwise stated, all amounts given are % by weight.

TABLE 1
Comparative examples (experimental series 1): Flame retardant
molding compositions with the components as sole additives
in glass-fiber-reinforced PA 6.6.

| | | | | UL 94 | GWIT/IEC |
|---|---|---|---|---|---|
| Comparative | DEPAL | | Br—PS | classification | 60695-2-13 |
| examples | [%] | MPP [%] | [%] | (0.8 mm) | [° C.] |
| 1 | 0 | 0 | 0 | n.c.^{*)} | 550 |
| 2 | 10 | 5 | 0 | V-0 | 700 |
| 3 | 0 | 10 | 0 | n.c. | 650 |
| 4 | 10 | 0 | 0 | V-2 | 650 |
| 5 | 0 | 0 | 10 | n.c. | 550 |
| 6 | 0 | 0 | 20 | n.c. | 550 |
| 7 | 0 | 0 | 30 | V-2 | 700 |

^{*)}n.c. = not classifiable

TABLE 2
Inventive examples: Flame retardant molding compositions
with the combination of DEPAL with nitrogen synergist and
bromine flame retardant in glass-fiber-reinforced PA 6.6.

| | | | | UL 94 | GWIT/IEC |
|---|---|---|---|---|---|
| Examples | DEPAL | | Br—PS | classification | 60695-2- |
| invention | [%] | MPP [%] | [%] | (0.8 mm) | 13 [° C.] |
| 8 | 10 | 0 | 10 | V-0 | 850 |
| 9 | 10 | 5 | 5 | V-0 | 800 |
| 10 | 8 | 4 | 8 | V-0 | 800 |
| 11 | 5 | 5 | 5 | V-0 | 800 |

TABLE 3
Comparative examples: Flame retardant molding
compositions with the components as sole
additives in glass-fiber-reinforced PBT

| | | | | UL 94 | GWIT/IEC |
|---|---|---|---|---|---|
| Comparative | DEPAL | | PBBA | classification | 60695-2-13 |
| examples | [%] | MPP [%] | [%] | (0.8 mm) | [° C.] |
| 12 | 0 | 0 | 0 | n.c.^{**)} | 550 |
| 13 | 10 | 5 | 0 | V-0 | 700 |
| 14 | 0 | 10 | 0 | n.c. | 650 |
| 15 | 10 | 0 | 0 | V-2 | 650 |
| 16 | 0 | 0 | 10 | n.c. | 550 |
| 17 | 0 | 0 | 20 | n.c. | 650 |

^{**)}n.c. = not classifiable

TABLE 4
Inventive examples: Flame retardant molding
compositions with the combination of DEPAL with
nitrogen synergist and bromine flame
retardant in glass-fiber-reinforced PBT.

| | | | | UL 94 | GWIT/IEC |
|---|---|---|---|---|---|
| Examples | DEPAL | MPP | | classification | 60695-2-13 |
| (invention) | [%] | [%] | PBBA [%] | (0.8 mm) | [° C.] |
| 18 | 10 | 0 | 10 | V-0 | 850 |
| 19 | 10 | 5 | 5 | V-0 | 800 |
| 20 | 8 | 4 | 4 | V-0 | 800 |
| 21 | 5 | 5 | 5 | V-1 | 800 |

1. A flame retardant combination comprising, as component A, at least one phosphinic salt of the formula (I), at least one diphosphinic salt of the formula (II), at least one Polymer of the at least one phosphinic salt, at least one polymer of the at least one diphosphinic salt or mixtures thereof, 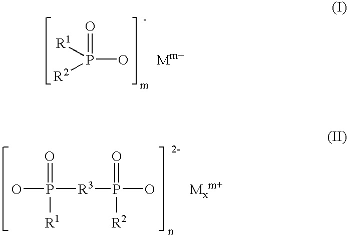
where
R¹, R² are identical or different and are C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na; K or a protonated nitrogen base;
m is from 1 to 4;
n is from 1 to 4;
x is from 1 to 4
and, as component B at least one synergistic halogen-containing component as component B.

2. The flame retardant combination as claimed in claim 1, wherein R¹ and R² are identical or different, and are C₁-C₆-alkyl, linear or branched, or phenyl.

3. The flame retardant combination as claimed in claim 1, wherein R¹ and R² are identical or different and are methyl, ethyl, n-propyl, isopropyl, n-butyl, tert-butyl, n-pentyl, or phenyl.

4. The flame retardant combination as claimed in claim 1, wherein R³ is methylene, ethylene, n-propylene, isopropylene, n-butylene, tert-butylene, n-pentylene, n-octylene or n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene, or phenylbutylene.

5. The flame retardant combination as claimed in claim 1, wherein the halogen-containing component B further comprises bromine- or chlorine-containing acid components, bromine- or chlorine-containing alcohol components, bromine- or chorine-containing aromatic compounds or bromine- or chlorine-containing aliphatic compounds.

6. The flame retardant combination as claimed in claim 5, wherein the bromine- or chlorine-containing acid components are selected from the group consisting of hexachloroendomethylenetetrahydrophthalic acid, tetrabromophthalic acid, tetrabromophthalic anhydride, trischloroethyl phosphate, and trischloropropyl phosphate.

7. The flame retardant combination as claimed in claim 5, wherein the bromine- or chlorine-containing aromatic compounds are selected from the group consisting of brominated polystyrenes, polybromobenzyl acrylates, tetrabromobisphenol A and derivatives, polybrominated diphenyl ethers, ethylenebistetrabromophthalimide, brominated epoxy oligomers, polybrominated diphenylethanes, hexabromocyclododecane, and dodecachloropentacyclooctadecadiene.

8. The flame retardant combination as claimed in claim 1 further comprising as component C, at least one nitrogen compound, phosphorus compound, or phosphorus-nitrogen compound.

9. The flame retardant combination as claimed in claim 8, wherein component C is selected from the group consisting of melamine phosphate, dimelamine phosphate, melamine pyrophosphate, melamine polyphosphates, melam polyphosphates, melem polyphosphates and melon polyphosphates.

10. The flame retardant combination as claimed in claim 8, wherein component C is a melamine condensate.

11. The flame retardant combination as claimed in claim 8, wherein component C is a nitrogen compound of the formulae (III) to (VIII), or a mixture thereof, 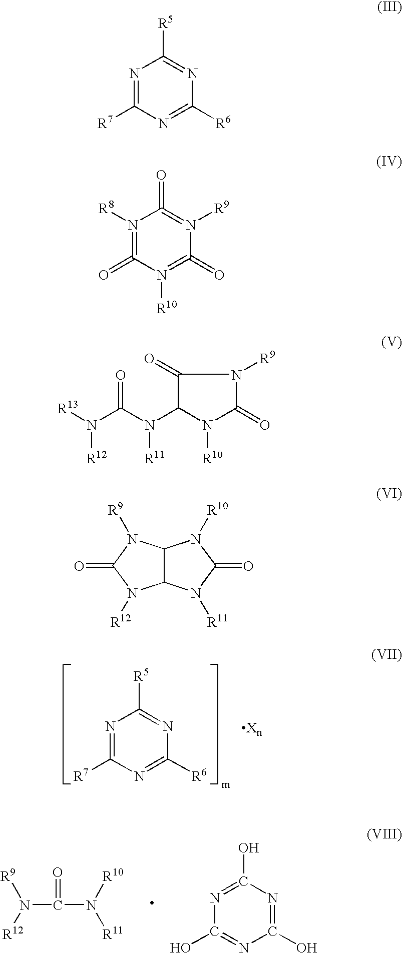
where
R⁵ to R⁷ are hydrogen, C₁-C₈-alkyl, C₅-C₁₆-cycloalkyl or -alkylcycloalkyl, C₁-C₈-alkoxy, -acyl, -acyloxy, C₆-C₁₂-aryl or -arylalkyl, —OR⁸, —N(R⁸)R⁹, or a system of N-alicyclic or N-aromatic nature,
R⁸ is hydrogen, C₁-C₈-alkyl, C₅-C₁₆-cycloalkyl or -alkylcycloalkyl, C₂-C₈-alkenyl, C₁-C₈-alkoxy, -acyl, -acyloxy, or C₆-C₁₂-aryl or -arylalkyl,
R⁹ to R¹³ are the same as the groups for R⁸, or —O—R⁸,
m and n, independently of one another, are 1, 2, 3, or 4,
X is an acid which forms adducts with triazine compounds (III).

12. The flame retardant combination as claimed in claim 8, wherein component C is selected from the group consisting of oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, guanidine, and carbodiimides.

13. The flame retardant combination as claimed in claim 8, wherein component C is a nitrogen-containing phosphate of the formulae (NH₄)_{y} H_{3-y} PO₄ or (NH₄ PO₃)_{z}, where y is from 1 to 3 and z is from 1 to 10 000.

14. The flame retardant combination as claimed in claim 1, further comprising as component D, a synthetic inorganic compound or a mineral product.

15. The flame retardant combination as claimed in claim 14, wherein component D is selected from the group consisting of an oxygen compound of silicon, magnesium compound, metal carbonate of metals of the second main group of the Periodic Table, red phosphorus, zinc compound, and an aluminum compound.

16. The flame retardant combination as claimed in claim 15, wherein the oxygen compound of silicon selected from the group consisting of salts and esters of orthosilicic acid and condensates thereof, silicates, zeolites, and silicas, glass powder, glass-ceramic powder, and ceramic powder.

17. The flame retardant combination as claimed in claim 1, further comprising from 0.1 to 99.9% by weight of component A and from 0.1 to 99.9% by weight of component B.

18. The flame retardant combination as claimed in claim 8, further comprising from 10 to 70% by weight of component A and from 10 to 70% by weight of component B, and from 0 to 60% by weight of component C.

19. The flame retardant combination as claimed in claim 1, further comprising from 20 to 65% by weight of component A and from 15 to 65% by weight of component B.

20. The flame retardant combination as claimed in claim 1, further comprising from 30 to 60% by weight of component A and from 30 to 50% by weight of component B.

21. (Cancelled)

22. A thermoplastic polymer comprising a flame retardant combination as claimed in claim 1.

23. The thermoplastic polymer as claimed in claim 22, wherein the thermoplastic polymer is selected from the group consisting of Hi (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene).

24. The thermoplastic polymer as claimed in claim 22 or 23, wherein, component A is used at a concentration of from 0.1 to 50% by weight, component B at a concentration of from 0.1 to 30% by weight, based on the thermoplastic polymer.

25. The thermoplastic polymer as claimed in claim 22, further comprising, as component C, at least one nitrogen compound, phosphorus compound, or phosphorus-nitrogen compound and wherein, component A is used at a concentration of from 3 to 40% by weight, component B at a concentration of from 1 to 25% by weight, and component C at a concentration of from 3 to 20% by weight, based on the thermoplastic polymer.

26. The thermoplastic polymer as claimed in claim 25, wherein, component A is present at a concentration of from 5 to 30% by weight, component B at a concentration of from 2 to 15% by weight, and component C at a concentration of from 4 to 15% by weight, on the thermoplastic polymer.

27. The flame retardant composition as claimed in claim 5, wherein the bromine- or chlorine-containing alcohol component is dibromopentyl glycol.

28. The flame retardant composition as claimed in claim 5, wherein the bromine- or chlorine-containing aliphatic compound is a chloroparaffin.

29. The flame retardant combination as claimed in claim 10, wherein the melamine condensate is a melam, melem or melon condensate.

30. The flame retardant composition as claimed in claim 11, wherein R⁵ to R⁷ are C₁-C₈-alkyl, C₅-C₁₆-cycloalkyl or -alkylcycloalkyl substituted with a hydroxy or C₁-C₄ hydroxyalkyl function.

31. The flame retardant composition as claimed in claim 11, wherein R⁸ C₁-C₈-alkyl, C₅-C₁₆-cycloalkyl or -alkylcycloalkyl substituted with a hydroxy or C₁-C₄ hydroxyalkyl function.

32. The flame retardant composition as claimed in claim 15, wherein the magnesium compound is selected from the group consisting of magnesium hydroxide, hydrotalcites, magnesium carbonates, and magnesium calcium carbonates.

33. The flame retardant composition as claimed in claim 15, wherein the zinc compound is selected from the group consisting of zinc oxide, zinc stannate, zinc hydroxystannate, zinc phosphate, zinc borate, and zinc sulfide.

34. The flame retardant composition as claimed in claim 15, wherein the aluminum compound is selected from the group consisting of aluminum hydroxide and aluminum phosphate.
